(19) United States
(12) Patent Application Publication
(10) Pub. No.: US 2014/0119810 A1
(43) Pub. Date: May 1, 2014

(54) STEERING WHEEL SHAFT RETENTION MECHANISM ASSEMBLY AND SERVICE TOOL

(71) Applicants: Melvin Lee Tinnin, Clio, MI (US); Michael W. Clark, Essexville, MI (US)

(72) Inventors: Melvin Lee Tinnin, Clio, MI (US); Michael W. Clark, Essexville, MI (US)

(21) Appl. No.: 13/665,152

(22) Filed: Oct. 31, 2012

(51) Int. Cl. B25G 3/28

(52) U.S. Cl. 403/20

(57) ABSTRACT

A steering wheel shaft retention mechanism assembly includes a steering shaft having a mounting groove, a retention mechanism positioned in the mounting groove and having at least one resilient locking projection, and a steering wheel hub having an opening configured to receive a portion of the steering shaft. One section of the opening is configured to receive the at least one locking projection to prevent removal of the steering wheel hub from the shaft. A service tool includes a body portion to be gripped by a user and an engaging portion having at least one projection extending from the body portion, the at least one projection configured to engage the at least one locking projection such that the at least one locking projection is moved to an unlocked position and the steering wheel hub is movable relative to the steering shaft for removal from the steering shaft.

### BACKGROUND OF THE INVENTION

The following description relates to a service tool to remove a retention mechanism positioned on a steering shaft that is configured to retain a steering wheel hub to the steering shaft.

In a steering column, a retention mechanism may be used to secure a steering wheel hub to a steer shaft. For example, a threaded bolt may be received through the steering wheel hub and threadably engage an interior bore within the steering shaft. However, during assembly, the threaded bolt may be improperly installed, or inadvertently not installed at all.

Accordingly it is desirable to provide an additional or alternative retention mechanism to secure the steering wheel hub to the steering shaft and a service tool configured to operate the retention mechanism so that the steering wheel hub may be removed from the steering shaft.

### SUMMARY OF THE INVENTION

According to an exemplary embodiment of the present invention, there is provided a steering wheel shaft retention mechanism assembly having a steering column and a service tool, the steering column including a steering shaft having a mounting groove, a retention mechanism positioned in the mounting groove, the retention mechanism including at least one resilient locking projection configured move between a locked position and an unlocked position and a steering wheel hub including an opening configured to receive a portion of the steering shaft, the opening having a first section having a first inner diameter and a second section having a second inner diameter greater than first inner diameter such that a circumferential gap is formed between an outer diameter of the steering shaft and an inner diameter of the second section of the opening. The steering wheel hub further includes an axially facing wall extending between the first section and second section, the second section configured to receive the at least one locking projection and, in the locked position, the at least one locking projection abuts against the axially facing wall to prevent removal of the steering wheel hub from the steering shaft. The service tool includes a body portion configured to be gripped by a user and an engaging portion including at least one projection extending from the body portion, the at least one projection configured to be received within the circumferential gap and engage the at least one locking projection such that the at least one locking projection is moved to the unlocked position and the steering wheel hub is movable relative to the steering shaft for removal from the steering shaft.

According to another exemplary embodiment of the present invention, there is provided a steering wheel shaft retention mechanism service tool having a body portion configured to be gripped by a user and an engaging portion having at least one projection extending from the body portion, the at least one projection configured to be received within a circumferential gap formed between a steering shaft and a steering wheel hub installed on the steering shaft. The at least one projection is further configured to engage at least one locking projection of a retention mechanism positioned on the steering shaft, such that the at least one locking projection is moved from a locked position to an unlocked position so that the steering wheel hub is movable relative to the steering shaft for removal from the steering shaft.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a service tool according to an exemplary embodiment of the present invention;

FIG. 2 is a perspective view of a service tool according to an alternative exemplary embodiment of the present invention;

FIG. 3 is an exploded perspective view of a steering shaft and retention mechanism according to an exemplary embodiment of the present invention;

FIG. 4 is a perspective view of the steering shaft and retention mechanism of FIG. 3 assembled together according to an exemplary embodiment of the present invention;

FIG. 5 is perspective view of a steering shaft and retention mechanism assembled together according to an alternative exemplary embodiment of the present invention;

FIG. 6 is a cross-section of a steering shaft, retention mechanism and steering wheel hub according to an exemplary embodiment of the present invention;

FIG. 7 is a cross-section of a steering shaft, retention mechanism, steering wheel hub and service tool with the service tool disengaged from the retention mechanism according to an exemplary embodiment of the present invention; and

FIG. 8 is a cross-section of a steering shaft, retention mechanism, steering wheel hub and service tool with the service tool engaging the retention mechanism according to an exemplary embodiment of the present invention.

### DETAILED DESCRIPTION

Referring now to the Figures, where the invention will be described with reference to specific embodiments, without limiting same, a service tool for operating a retention mechanism so that a steering wheel hub and the retention mechanism may be removed from a steering shaft is provided.

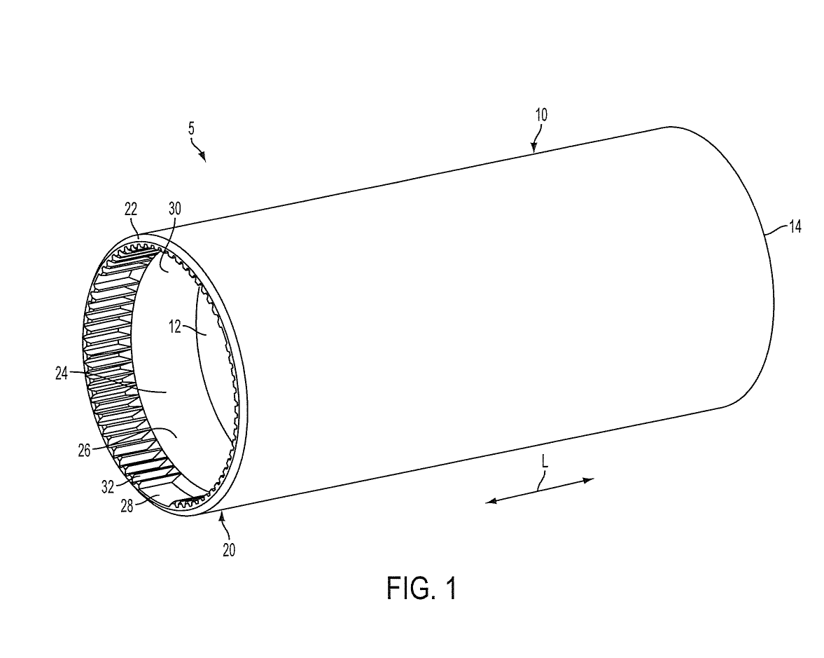

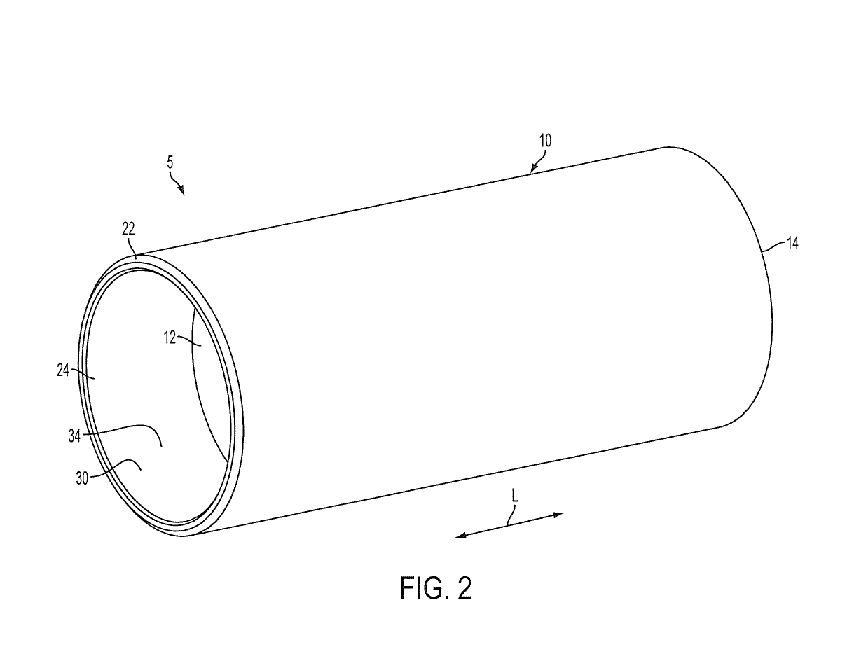

With reference to FIGS. 1 and 2, in accordance with an exemplary embodiment of the present invention, the service tool 5 includes a body portion 10 and an engaging portion 20. The body portion 10 includes a first end 12 and a second end 14 and is configured to be handled by a user to operate the service tool. Accordingly, the body portion 10 may be of any shape and/or size suitable for gripping by the user. In an exemplary embodiment, the body portion 10 is generally cylindrical in shape with a circular cross section and extends in a length direction ‘L’. The body portion 10 may also include ergonomic shapes and/or features to provide increased comfort to a user gripping the service tool 5. The body portion may be of sufficient length and diameter so that the user may easily grip and manipulate the service tool 5.

It is understood that the body portion 10 of the service tool 5 described above is provided for the purposes of example only, and the body portion 10 is not limited to the description above. For example, the body portion 10 may be formed of a different shape, such as a generally oval, square, rectangular or other cross-sectional shape. In addition, the thickness or diameter of the body portion may vary along the length thereof. Further still, the body portion 10 may be curved along its length.

The engaging portion 20 is positioned at the first end 12 of the body portion 10. The engaging portion 20 is configured to engage and operate the retention mechanism as described below. The engaging portion 20 includes at least one projection 22 extending outwardly from the first end of the body portion 10. In an exemplary embodiment, the at least one projection 22 extends continuously around a perimeter or circumference of the body portion 10 and extends outwardly from the first end 12 of the body portion 10 in the length direction ‘L’. A recess 24 is formed within the engaging portion 20 and is bounded by the at least one continuous projection 22 and the first end 12 of the of the body portion 10. The recess 24 is configured to receive a portion of the steering shaft as discussed below.

It is understood that the engaging portion 20 is not limited to the exemplary embodiment described above. For example, the at least one projection 22 may be a single projection or more than one discrete projection extending from the first end 12 of the body portion 10 in the length direction ‘L’, and spaced apart from one another along the perimeter or circumference of the body portion 10.

The recess 24 may have a constant diameter or includes sections of different diameters. With reference to FIG. 1, in an exemplary embodiment, the recess 24 includes a first diameter section 26 and a second diameter section 28. The first diameter section 26 has a smaller diameter than the second diameter section 28. An inward facing surface 30 of the at least one projection 22 faces the recess 24 and bounds the first diameter section 26 and second diameter section 28.

With further reference to FIG. 1, a plurality of splines 32 extending generally in a length direction ‘L’ and spaced apart in the circumferential direction are formed along a portion of the inward facing surface 30. In an exemplary embodiment, the splines 32 are formed in the second diameter section 28 and project radially inward to a position that is substantially flush with inward facing surface 30 of the first diameter section 26. The splines 32 may be used to ensure proper positioning and/or keying of the service tool 5 with respect to the steering column.

Alternatively, and with reference to FIG. 2, the recess 24 may be formed with a constant diameter section 34 extending along the length of the at least one projection. In an exemplary embodiment with the constant diameter section 34, the inward facing surface 30 presents a continuous, flush surface and may be free of splines. It is understood that the configurations above are not limiting and are exemplary in nature. Other suitable configurations are envisioned, such as a configuration where splines extend along the length of the constant diameter section 34 described above.

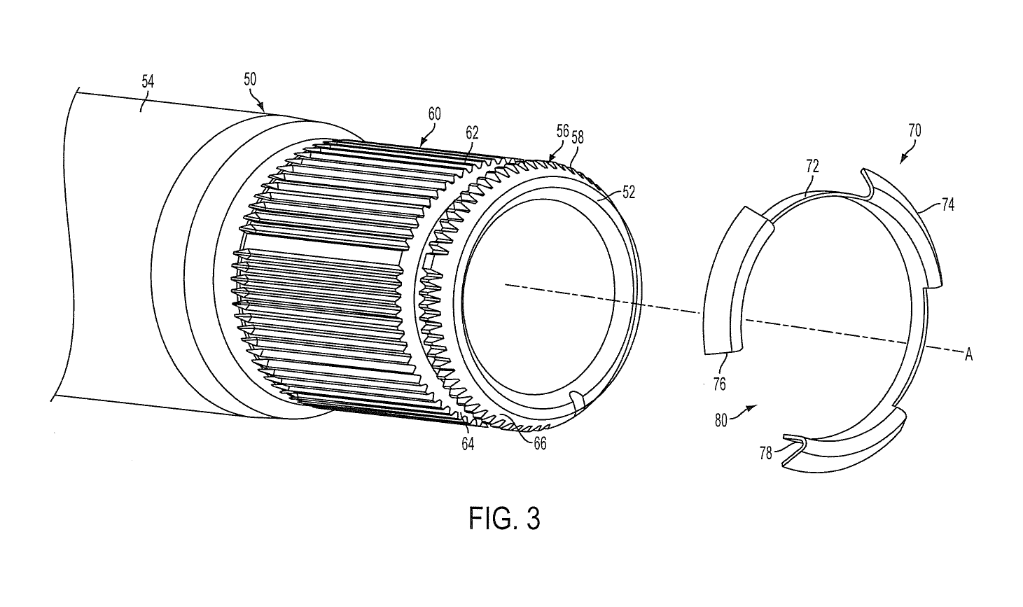

The service tool 5 is configured to a be used together as system with a steering column 40 having a steering shaft 50, retention mechanism 70 and steering wheel hub 90 of the type described hereafter and shown in FIGS. 3-8.

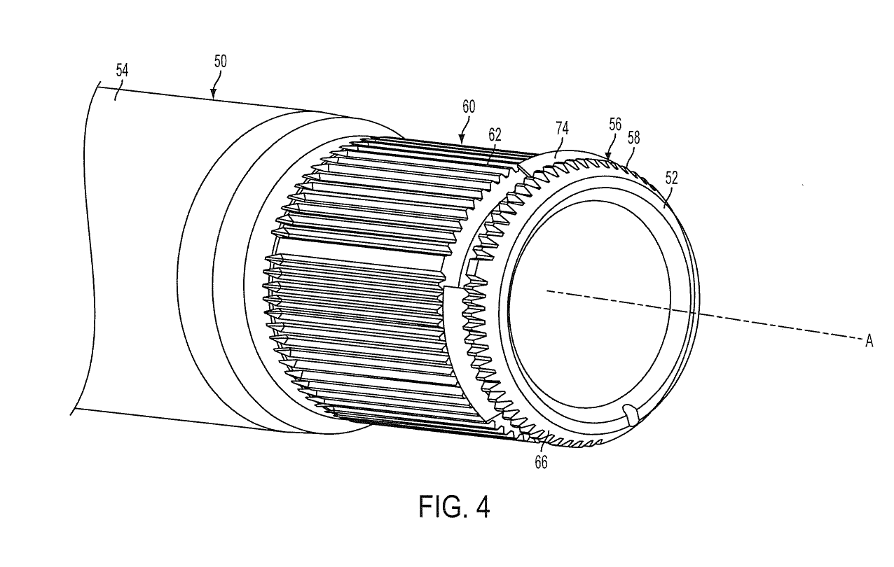

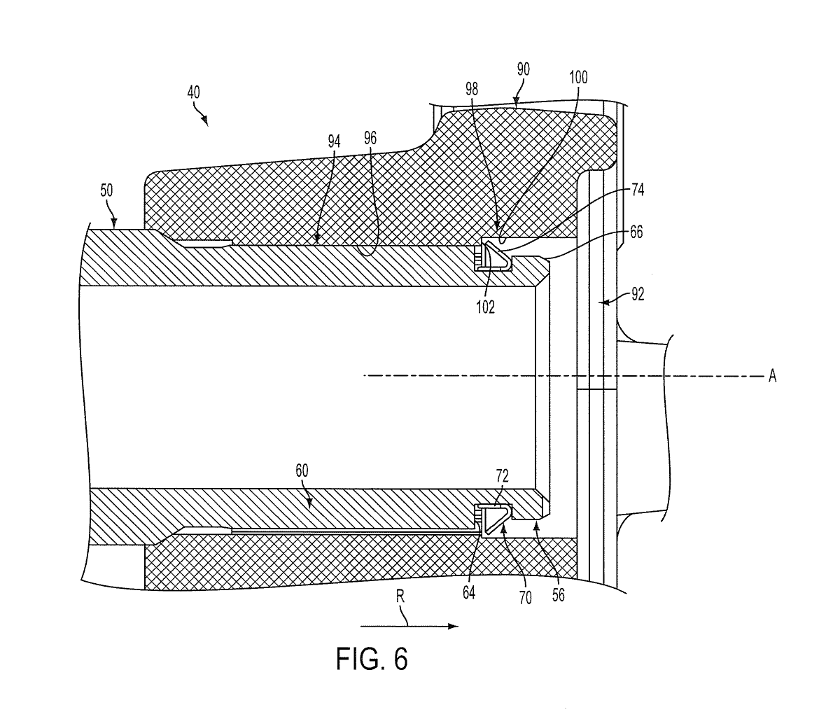

With reference to FIGS. 3-6, in an exemplary embodiment of the present invention, the steering column 40 includes a steering shaft 50 extending along an axis ‘A’, a retention mechanism 70 and a steering wheel hub 90 (FIG. 6). In an exemplary embodiment, and with reference to FIGS. 3 and 4, the steering shaft 50 includes a first end 52 and an outer surface 54. The outer surface 54 includes a first shaft section 56, which, in an exemplary embodiment includes first splines 58 circumferentially spaced from one another and a second shaft section 60, which in an exemplary embodiment includes second splines 62 circumferentially spaced from one another. The first shaft section 56 is spaced from the second shaft section 60 by a mounting groove 64. In an exemplary embodiment, the first splines 58 and second splines 62 extend axially in the direction of axis ‘A’. An outer diameter of the first shaft section 56 may be substantially the same as an outer diameter of the second shaft section 60.

The steering shaft 50 may also include a beveled portion 66 extending about the first end 52 around the circumference of the steering shaft 50. The beveled portion 66 may extend inwardly from the first end 52 such a portion of the first splines 58 are beveled as well. The beveled portion 66 may assist in positioning the steering wheel hub 90 on the steering shaft 50 and installation retention mechanism 70 as further described below.

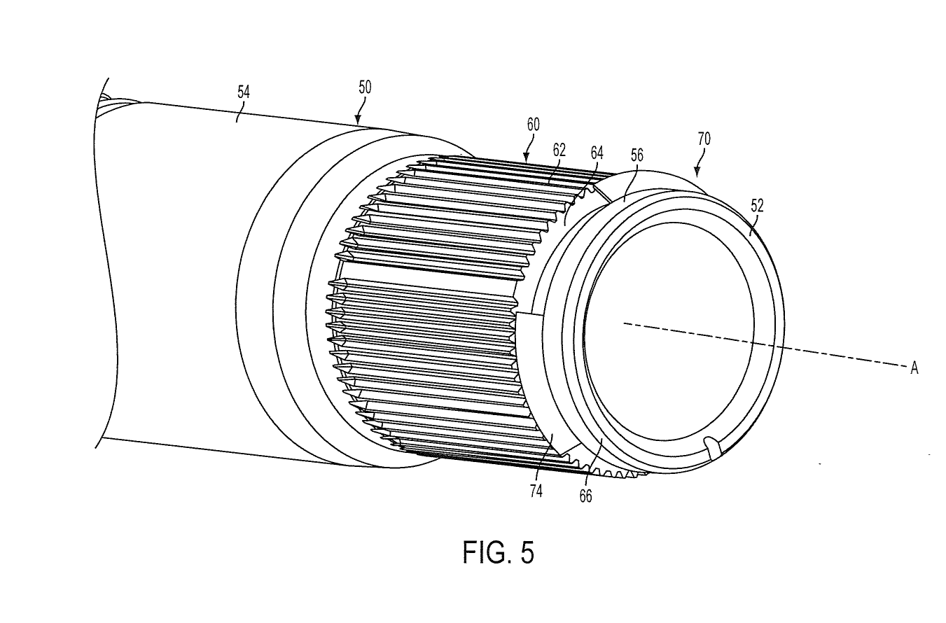

Alternatively, with reference to FIG. 5, the first shaft section 56 does not necessarily include first splines 58. That is, the first shaft section 56, as shown in FIG. 5, may be formed with an outer circumferential surface that is generally uniform. That is, the outer circumferential surface does not include any projections or splines. In an exemplary embodiment, the first shaft section 56 may have a smaller outer diameter than the second shaft section 60. It is understood that various features of the exemplary embodiment described with reference to FIG. 5 may be used together with or replace features of other exemplary embodiments described herein, and vice versa. For example, the first shaft section 56 shown in FIG. 5 may have a smaller outer diameter than the second shaft section 60 and also include the first splines 58 described above.

With further reference to FIGS. 3 and 4, in accordance with an exemplary embodiment of the present invention, the retention mechanism 70 may include an attaching portion 72 and a resilient locking portion 74. The attaching portion 72 is configured to be received in the mounting groove 64 of the steering shaft 50 and the locking portion 74 is configured to project outwardly from attaching portion 72. The retention mechanism 70 may be made from an elastically resilient material such as spring steel.

In an exemplary embodiment, the attaching portion 72 is formed in a partially annular shape and includes a first end 76 and a second end 78 spaced from the first end by a gap 80, to allow for flexibility of the retention mechanism 70 during installation and removal.

Referring to FIGS. 3-5, the locking portion 74 is formed as at least one locking projection. The at least one locking projection 74 extends radially outward from the attaching portion 72 (FIG. 3) and may be angled away from the first end 52 of the steering shaft 50 when installed thereon. That is, the at least one locking projection 74 may form an obtuse angle relative to the steering shaft in a direction toward the first end 52 of the steering shaft.

Each locking projection 74 is movable between a first, locking position and a second, unlocking position, and is urged toward the first position under a spring force due to the elastically resilient nature of the material from which the retention mechanism 70 is made. In the locking position, the at least one locking projection 74 extends outwardly to a position beyond the first and second outer diameters of the steering shaft 50. In the unlocking position, the at least one locking projection 74 is deflected radially inward from the locked position, and for example, may extend no further outward than the second outer diameter of the steering shaft 50. In an exemplary embodiment, the retention mechanism 70 includes three locking projections 74 circumferentially spaced from one another along the attaching portion 72. It is understood that the present invention is not limited to the examples above, and that any suitable number of locking projections 74 may be used.

It is also understood that the retention mechanism 70 is not limited to the exemplary embodiments described above, and other configurations are envisioned. For example, the retention mechanism 70 may be an elastically resilient partially annular ring having a generally constant thickness a radial direction. The partially annular ring may be shaped such that when it is positioned in the mounting groove 64 on the steering shaft 50, at one point or portion along the ring, the ring is spaced from the mounting groove 64 such that a radially outer surface along the point or portion projects beyond a radial extent of the steering shaft and acts as the at least one locking projection 74.

With reference to FIG. 6, the steering wheel hub 90 is configured to be attached to the steering shaft 50. The steering wheel hub 90 includes an opening 92 positioned about and extending along the axis ‘A’. The opening 92 includes a first section 94 having a first inner diameter and defining a first radially inward facing surface 96 and a second section 98 having a second inner diameter and defining a second radially inward facing surface 100. The second inner diameter of the second section 98 is larger than the first inner diameter of the first section 94. An axially facing wall 102 is formed between the first section 94 and the second section 98 and extends from the first radially inward facing surface 96 to the second radially inward facing surface 100.

The first radially inward facing surface 96 of the first section 94 may include a plurality of circumferentially spaced splines (not shown). In an exemplary embodiment, the splines (not shown) extend axially in the direction of the axis ‘A’. The splines of the first radially inward facing surface 96 may be received between the second splines 62 of the steering shaft 50 to substantially fix the steering hub 90 against rotation relative to the steering shaft 50.

With further reference to FIG. 6, with the steering column 40 assembled, retention mechanism 70 is positioned in the mounting groove 64 of the steering shaft 50. The first end 52 of the steering shaft 50 is inserted into the opening 92 of the steering wheel hub 90 such that the first and second shaft sections 56, 60 of the steering shaft 50 are received within opening 92. In particular, the first shaft section 56 is positioned in the second section 98 of the steering wheel hub opening 92 and the second shaft section 60 is positioned in the first section 94 of the steering wheel hub opening 92. In an exemplary embodiment, the second splines 62 of the second shaft section 60 are engaged between the splines (not shown) positioned on the first radially inward facing surface 96 of the first section 94 of the opening 92. This configuration substantially fixes the steering wheel hub 90 against rotation relative to the steering shaft 90.

The at least one locking projection 74, in the locked position, projects from the mounting groove 64 of the steering shaft 50 into the second section 98 of the opening 92 of the steering wheel hub 90. The at least one locking projection 74 extends radially beyond the first and second outer diameters of the steering shaft 50. The at least one locking projection 74 is configured to prevent removal of the steering wheel hub 90 from the steering shaft 50 by coming into contact with the axially facing wall 102 when the steering wheel hub 90 is moved in a removal direction ‘R’.

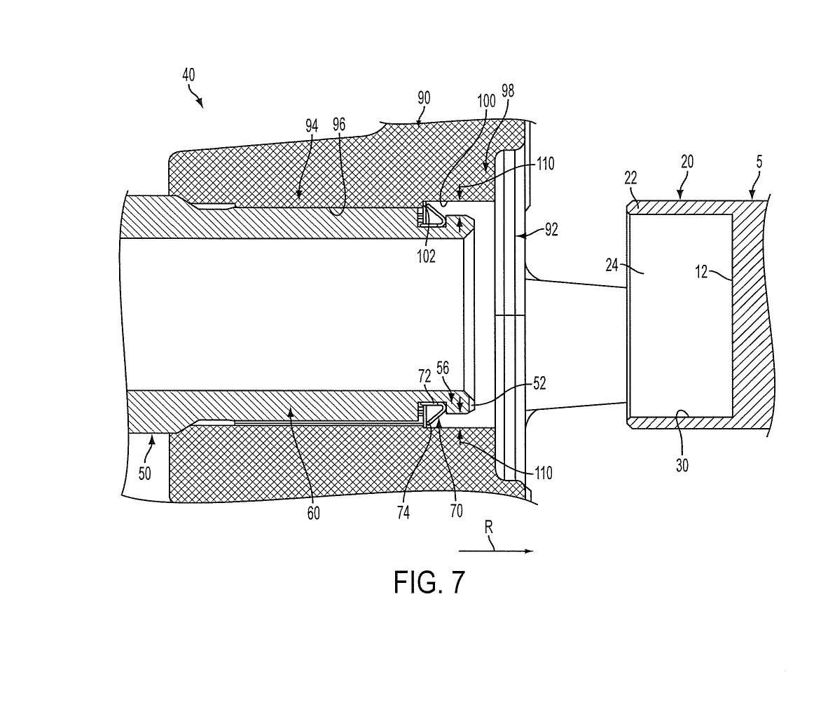

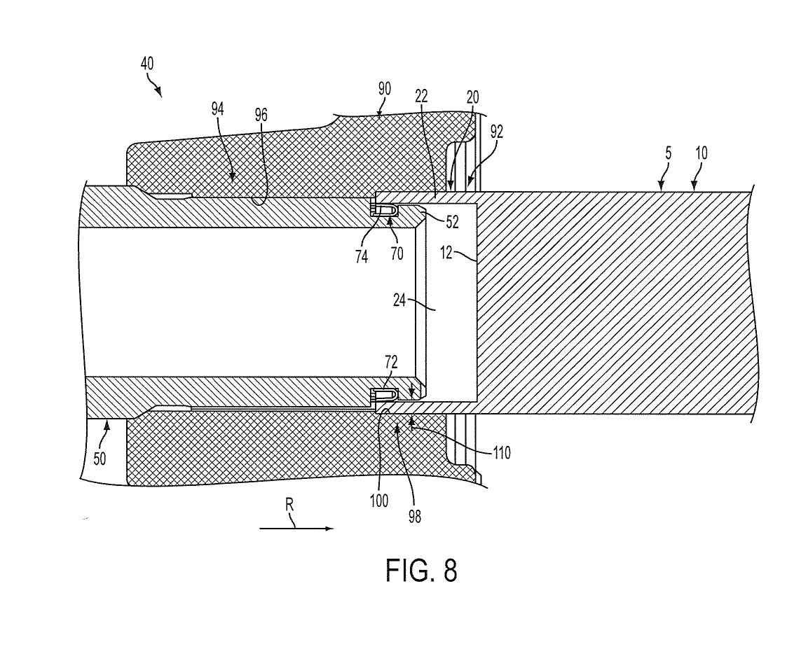

With reference to FIGS. 7 and 8, a circumferential gap 110 is formed between the first outer diameter of the first shaft section 56 and the second inner diameter, or the second inwardly facing surface 100, of the second section 98 of the opening 92 in the steering wheel hub 90. The circumferential gap 110 allows access to the at least one locking projection 74 of the retention mechanism 70, so that the retention mechanism 70 may be operated to allow movement of the steering wheel hub 90 in the removal direction ‘R’ relative to the steering shaft 50.

In operation, the user may grip the body portion 10 of the service tool 5, and move the service tool 5 toward the retention mechanism 70. The engaging portion 20 is received in the circumferential gap 110. In particular, the at least one projection 22 of the engaging portion 20 is received in the circumferential gap 110. It is understood that the position and number of projections 22 of the engaging portion 20 may correspond to the position and number of the locking projections 74 of the retention mechanism 70, the at least one projection 22 may be a continuous projection extending along the circumference or perimeter of the of the service tool 5, or the engaging portion 20 may include any predetermined number of discrete projections 22.

With the engaging portion 20 received in the circumferential gap 110, the first end 52 of the steering shaft 50 may be received in the recess 24 of the engaging portion 20. Further, in the exemplary embodiment of the present invention where an inward facing surface 30 of the at least one projection 22 includes splines 32, the splines 32 may be engaged between the first splines 58 of the first shaft section 56.

With reference to FIG. 8, the at least one projection 22 engages the at least one locking projection 74 and deflects the at least one locking projection 74 to the unlocking position. In the unlocking position, the at least one locking projection 74 is positioned radially within the first inner diameter of the first section 94 of the opening 92 in the steering wheel hub 90. Accordingly, with the at least one locking projection 74 in the second, unlocking position, the steering wheel hub 90 may be moved in the removal direction ‘R’ relative to the steering shaft 50 to be removed from the steering shaft 50.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering wheel shaft retention mechanism assembly comprising a steering column and a service tool, the steering column comprising:
a steering shaft having a mounting groove;
a retention mechanism positioned in the mounting groove, the retention mechanism comprising at least one resilient locking projection configured move between a locking position and an unlocking position;
a steering wheel hub comprising an opening configured to receive a portion of the steering shaft, the opening comprising a first section having a first inner diameter and a second section having a second inner diameter greater than first inner diameter such that a circumferential gap is formed between an outer diameter of the steering shaft and an inner diameter of the second section of the opening, the steering wheel hub further comprising an axially facing wall extending between the first section and second section, the second section configured to receive the at least one locking projection and, in the locked position, the at least one locking projection abuts against the axially facing wall to prevent removal of the steering wheel hub from the steering shaft; and
the service tool comprising a body portion configured to be gripped by a user;
and an engaging portion comprising at least one projection extending from the body portion, the at least one projection configured to be received within the circumferential gap and engage the at least one locking projection such that the at least one locking projection is moved to the unlocking position and the steering wheel hub is movable relative to the steering shaft for removal from the steering shaft.

2. The assembly of claim 1, the at least one projection of the service tool comprises a continuous projection extending completely along a perimeter of the body portion.

3. The assembly of claim 2, wherein a recess is formed within the continuous projection, the recess configured to receive a first end of the steering shaft when the service tool is engaged with the locking projection.

4. The assembly of claim 3, wherein a plurality of splines are formed along an inner surface of the continuous projection.

5. The assembly of claim 1, wherein the at least one projection of the service tool comprises a plurality of discrete, spaced apart, projections extending from the body portion.

6. The assembly of claim 1, wherein the retention mechanism comprises an attaching portion configured to be received within the mounting groove, and the at least one locking projection comprises a plurality of spaced apart locking projections extending from the attaching portion.

7. The assembly of claim 1, wherein the steering shaft comprises a first shaft section and a second shaft section, the first shaft section spaced from the second shaft section by the mounting groove.

8. The assembly of claim 7, wherein the second shaft section of the steering shaft includes a plurality of splines and is configured to be received in the first shaft section of the opening of the steering shaft.

9. The assembly of claim 8, wherein the first shaft section of the steering shaft includes a plurality of splines and is configured to be received within the second section of the opening of the steering wheel hub.

10. The assembly of claim 9, wherein the first shaft section of the steering shaft has a first outer diameter, the second shaft section of the steering shaft has a second outer diameter greater than the first outer diameter, and the circumferential gap is formed between the first outer diameter of the first shaft section and the second inner diameter of the second section of the opening of the steering wheel hub.

11. A steering wheel shaft retention mechanism service tool comprising:
a body portion configured to be gripped by a user; and
an engaging portion comprising at least one projection extending from the body portion, the at least one projection configured to be received within a circumferential gap formed between a steering shaft and a steering wheel hub installed on the steering shaft, the at least one projection further configured to engage at least one locking projection of a retention mechanism positioned on the steering shaft, such that the at least one locking projection is moved from a locking position to an unlocking position so that steering wheel hub is movable relative to the steering shaft for removal from the steering shaft.

12. The service tool of claim 11, wherein the at least one projection comprises a continuous projection extending completely along a perimeter of the body portion.

13. The service tool of claim 12, wherein a recess is formed within the continuous projection, the recess configured to receive a first end of the steering shaft when the service tool is engaged with the locking projection.

14. The service tool of claim 13, where a plurality of splines are formed along an inner surface of the continuous projection.
